(19) United States
(12) Patent Application Publication
(10) Pub. No.: US 2014/0344173 A1
(43) Pub. Date: Nov. 20, 2014

(54) SYSTEM AND METHOD FOR CREATING EXECUTABLE POLICY RULES FOR EXECUTION ON RULES-BASED ENGINES

(71) Applicant: KPMG LLP, New York, NY (US)

(72) Inventor: Prabhakar JAYADE, Plainsboro, NJ (US)

(73) Assignee: KPMG LLP, New York, NY (US)

(21) Appl. No.: 14/243,682

(22) Filed: Apr. 2, 2014

Related U.S. Application Data
(60) Provisional application No. 61/807,384, filed on Apr. 2, 2013.

(51) Int. Cl. G06Q 30/00; G06F 17/30

(52) U.S. Cl. CPC G06Q 30/018; G06F 17/30289
USPC 705/317; 707/792

(57) ABSTRACT

A system and method of availing executable rules for performing a government regulation compliance review using a rules-based engine may include encoding assertions into a computer-executable format. The assertions may be converted from the computer-executable format to a conventional rules-based format. The assertions in the rules-based format may be available for execution in a rules-based engine for applying the assertions to business data being stored in a structured database.

### RELATED APPLICATIONS

This application claims priority to co-pending U.S. Provisional Application Ser. No. 61/807,384 filed Apr. 2, 2013 and entitled “System and Method for Client Onboarding”; the contents of which are hereby incorporated by reference in their entirety.

### BACKGROUND

Businesses are driven by rules. These rules are developed over time for efficiency purposes, risk reduction purposes, practical business execution purposes, and, often in the case of government regulated industries, regulation compliance purposes. Government regulations often contains thousands of regulations to be followed by industries. As an example, the banking industry is highly regulated and thousands of banking regulations exist for many, many reasons. As a regulatory example, to combat money laundering and terrorism, one recent significant government regulation is “Know Your Customer” (KYC) that requires a bank that is onboarding a potential customer to perform due diligence and examine relevant information of the potential customer prior to onboarding or otherwise working on behalf of the customer. For potential customers who are individuals, the compliance review process to comply with KYC regulations is relatively straight forward. However, for corporate customers, the process is extensive, time consuming, challenging, and expensive—even with using today's most advanced technical tools. The cost for each Tier-I bank just to comply with the KYC regulations may be upwards of $100 million per year. Other government regulations include Foreign Account Tax Compliant Act (FATCA), Dodd-Frank, Patriot Act, and so on. Each of these and the many other government regulations require strict compliance to avoid penalties by government regulators.

In complying with government regulations and business rules for various business processes, including client onboarding, there have historically been two methods used, including (i) a manual compliance process and (ii) a computer workflow compliance process. The manual compliance process typically is performed by one or more compliance reviews (i) having a paper or computer display listing of current business rules and government regulations with which to comply, and (ii) manually reviewing customer documents to ensure compliance with each of the company rules and government regulations. As well understood in the art, this manual compliance process is very time-consuming, costly, and inefficient. The computer workflow compliance process offers slightly more efficiency than the manual compliance process by uploading documents (e.g., customer operations documents) to an electronic document review system that typically (i) provides an electronic list of company rules and government regulations, and (ii) enables a reviewer to review the uploaded electronic documents as guided by the workflow process to determine compliance of the company rules and government regulations. While the workflow and other aspects of the computer workflow compliance process may be automated, the actual review of the documents that are subject to compliance is a manual process that requires a reviewer to manually review each document, albeit on a computer screen, and determine whether the document complies with the company rules and government regulations. Even with the computerized workflow compliance processes, Tier-I banks often have hundreds or thousands of compliance personnel to handle KYC compliance reviews, among other compliance issues. Moreover, inconsistency of onboarding practices and lack of a standardized data collection approach have created redundancy, re-work, delays, and errors in downstream processing functions. As such, there is a need for improved efficiencies to comply with company rules and government regulations.

As understood in the art, the effort and cost of reviewing in interpreting government rules and regulations to create computerized rules is significant and generally costs in the millions of dollars. As result, computerize processes for performing government compliance reviews have generally falling short of being optimal. As an example, many conventional systems have attempted to use traditional rules-based engines, but these systems have significant shortcomings in achieving a robust and efficient system. As an example, these rules-based engine systems typically require a user to manually interpret business documents to add business data to a structured database, such as a structured query language (SQL) database. As a result, it is generally understood that rules-based engine solutions are limited in their efficiencies.

### SUMMARY

In providing for a computerized solution that is optimal and efficient for performing government regulation compliance reviews, the principles of the present invention provide for the use of assertions using a resource description format (RDF), such as an RDF triple. While an optimal solution may be provided by creating the assertions as RDF triples, the principles of the present invention may also be used to support of conventional rules-based engine solutions despite being a less optimal solution by including a translator that translates the assertions from an RDF triple format to rules in a rules-based format.

One embodiment of a method of availing executable rules for performing a government regulation compliance review using a rules-based engine may include encoding assertions into a computer-executable format. The assertions may be converted from the computer-executable format to a conventional rules-based format. The assertions in the rules-based format may be available for execution in a rules-based engine for applying the assertions to business data being stored in a structured database.

One embodiment of a method for creating executable policy rules for a rules-based engine to execute may include modeling a set of policy interpretations derived from policies by which an organization is to comply during business operations to create a set of assertions. The set of assertions may be translated from a first ontology to be rules having a second ontology, where the rules having the second ontology may be configured to be executable by a rules-based engine to apply the rules to business data stored in a structured database.

### BRIEF DESCRIPTION

A more complete understanding of the method and apparatus of the present invention may be obtained by reference to the following Detailed Description when taken in conjunction with the accompanying Drawings wherein:

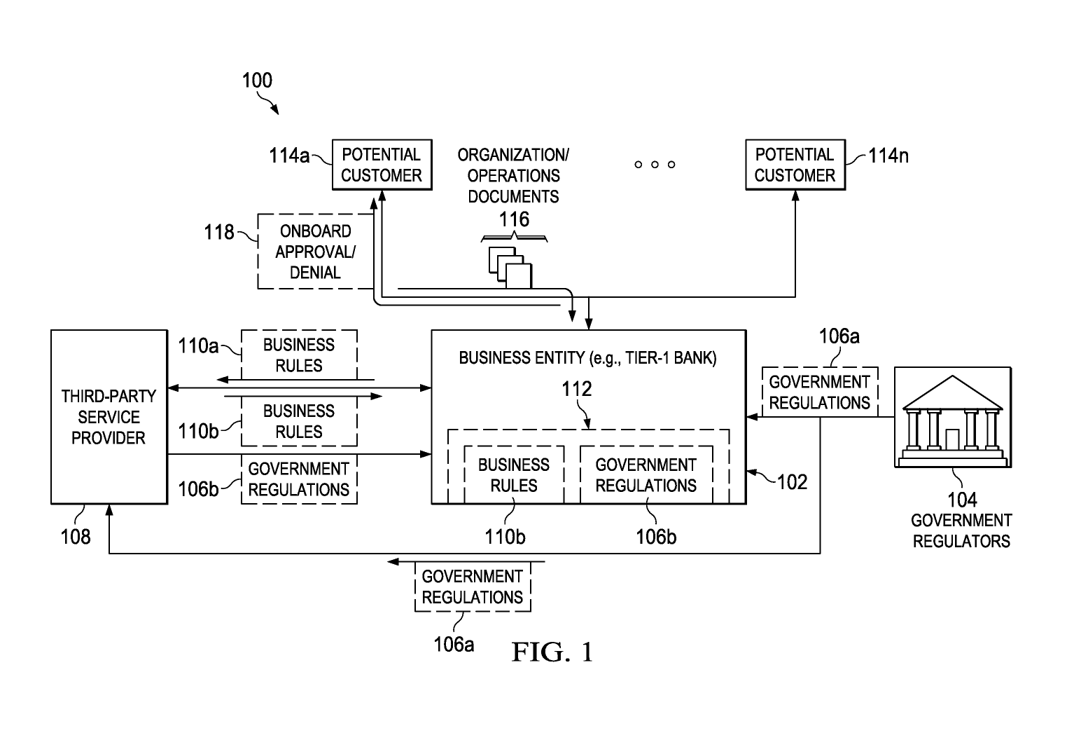

FIG. 1 is an illustration of an illustrative regulated business environment in which a business entity, such as a bank, operates under government regulations and performs Know Your Customer onboarding compliance reviews;

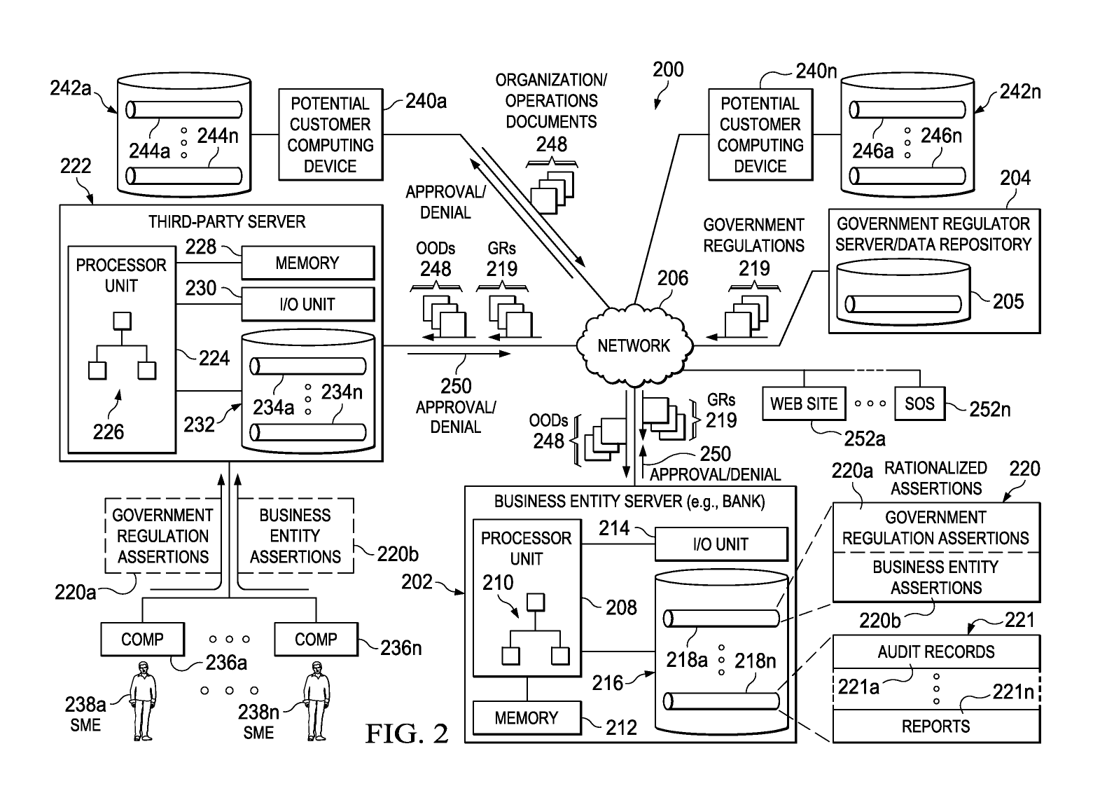

FIG. 2 is an illustration of an illustrative network environment of the business entity in supporting customer onboarding in the government regulated environment of FIG. 1 in accordance with the principles of the present invention;

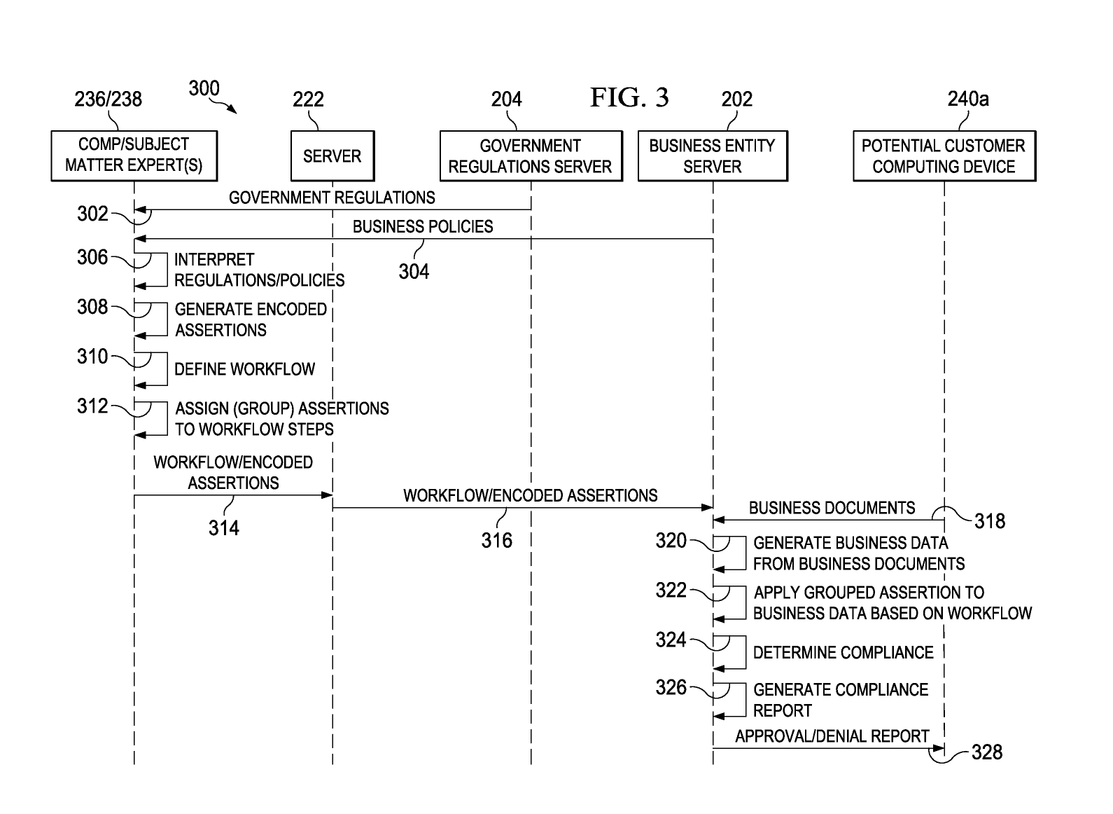

FIG. 3 is an interaction diagram of an illustrative process for a business entity to perform customer onboarding utilizing the principles of the present invention;

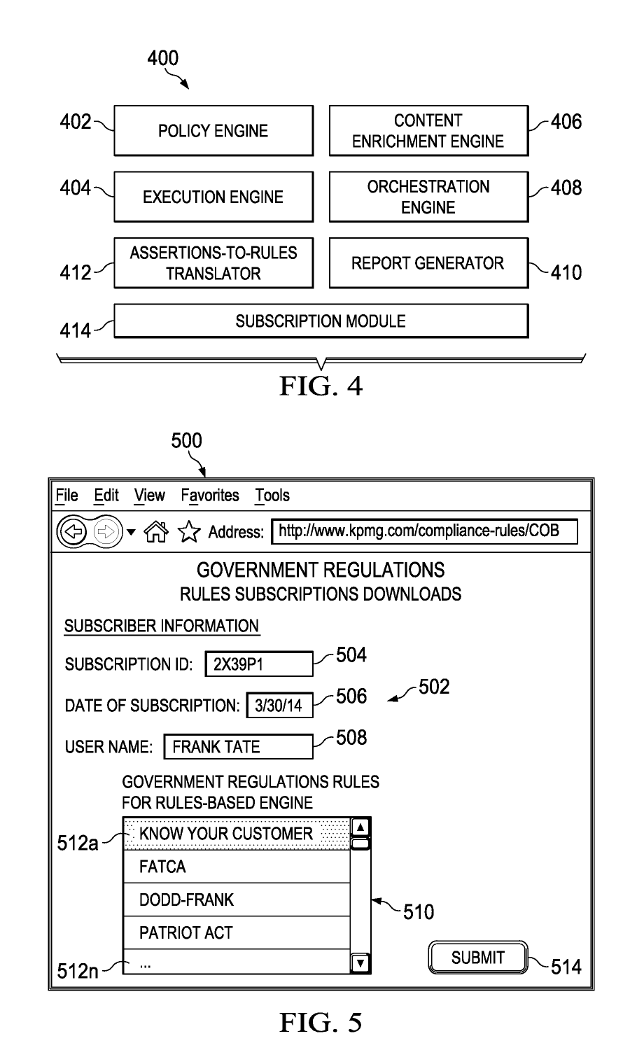

FIG. 4 is a block diagram of a illustrative modules that may be executed by a computing system for performing compliance of business data in accordance with the principles of the present invention;

FIG. 5 is a screenshot of an illustrative user interface that enables a user to download rules for government regulations from a third-party;

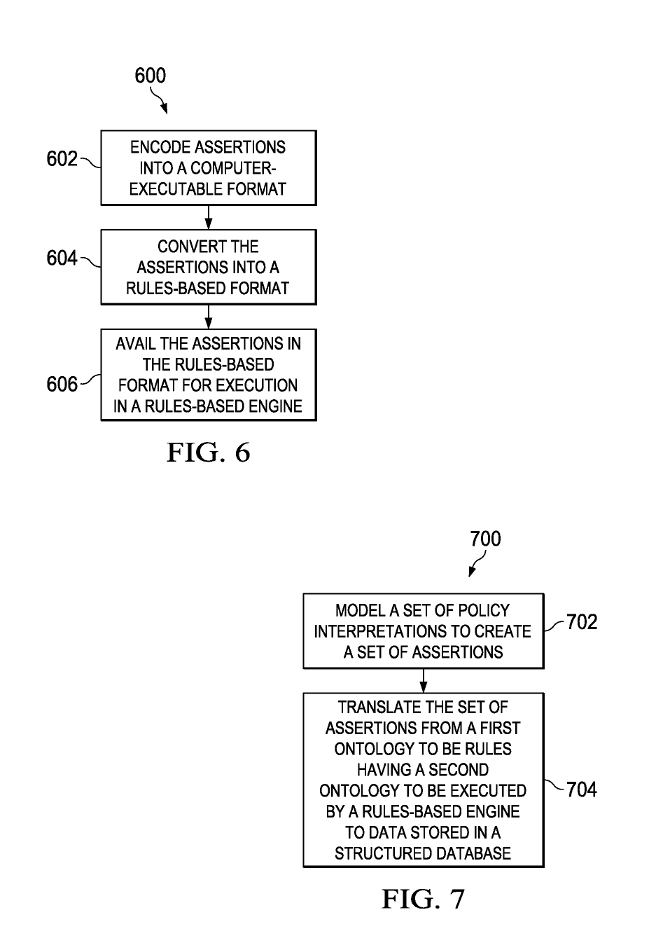

FIG. 6 is a flow diagram of an illustrative process for availing executable rules for performing a government regulation compliance review using a rules-based engine; and

FIG. 7 is a flowchart of illustrative process for creating executable policy rules for a rules-based engine to execute.

### DETAILED DESCRIPTION OF THE DRAWINGS

Most business strategy and operations, especially regulatory and compliance operations, can be modeled into a unique repeatable pattern, sometimes called business-behavior pattern. Business-behavior pattern can be solved by a combination of (i) the ability to process financial data as unstructured data and (ii) the ability to use business metadata modeling standards and tools to model government regulations, business rules, business risk, business operations, and regulatory policies.

With regard to business-behavior patterns, policy defines the “business,” and business transaction data represents “behavior.” The policies, which may include government regulations, business rules, and so on, are applied to the business data. Business data that does not conform to the policies represent “outlier” behavior. Outlier behavior is deemed “non-compliant” if the policies are regulatory, where the outlier behavior is “risk” if the policies are business (e.g., credit, market, operation) policies. The outlier behavior is “opportunity” if the policies are business development, and so on. Examples of long-standing industry issues that fit the business-behavior pattern include customer onboarding, reconciliation, legal entity rationalization, Basil 2.5/III, liquidity risk, compliance, and so on.

The most scrutinized aspect of any business, and more so of the financial services business, is the adherence of the business to government regulatory policies. The business-behavior pattern solves for the business adherence to government regulatory policy variables, among others.

Business behavior typically begins with vision and translates to specific goals, which ultimately translate to business policies. Business policies serve as guidelines for designing an organization and operations thereof, and ultimately become a tool for business governance to ensure ongoing business adheres to current business policies. In accordance with the principles of the present invention, three design elements may be used to define a pattern design, and these design elements include (i) decision model, (ii) semantic model, and (iii) governance model.

Decision models may be defined for computer execution using resource description format (RDF), which is an object management group/worldwide web consortium (OMG/W3C) standard that describes each policy-condition as an “assertion” that evaluates to a Boolean when tested against business data. The business models may be based on decision modeling notation (DMN), which is an emerging standard. Decision models may be made up of one or many decision-tables joined by association or hierarchy using ontology modeling notation. The ontology model notation provides for the following attributes for the pattern to be complete and available for computer-execution: assertions defined in RDF triples (subject-predicate-object), operators for the predicates, and Boolean to compound the assertions. The assertions defined in RDF triples may define a decision-table.

The semantic model provides a vocabulary that describes a domain to which the policies apply, namely the business (e.g., banking business). The semantic model also encodes the policies as assertions, and describes business documents that include business data in all forms, namely (i) unstructured (paper-based contracts, email, social media, web page, etc.), (ii) semi-structured (electronic forms), and (iii) structured (enterprise reference, position, and transaction data). Among other things, the semantic model includes very specific definitions of identity, such as fingerprinting, necessary and sufficient conditions, including completeness, and so on. In broader terms, the semantic model defines the data quality rules from a business perspective.

The semantic model may incorporate a content enrichment framework that creates tags, such as XML tags, to unstructured data by using the vocabulary of the semantic model to create the enrichment tags. Business data that has been content enriched with tags may be stored in a non-structured database, such as a NoSQL database, which provides more flexibility than a structured database, such as a SQL database. These tags may be indexed by an execution engine so that the business data can be searched in an unstructured search format (e.g., keyword search tool for analysts/case workers to research open cases). In one embodiment, the search may incorporate a “fuzzy search” feature that uses the semantic model to render the fuzzy search when identifying “values” between the enrichment tags. As understood in the art, a fuzzy search allows for closeness of a match to be measured in terms of a number of “primitive operations” necessary to convert a search string into an exact match. The number is known as the “edit distance” between the search string and the pattern, and typically look for words that have insertions (e.g., cot→coat), deletions (e.g., coat→cot), substitutions (e.g., coat→cost), transpositions (e.g., cost→cots), and abbreviations (e.g., Ltd.→Limited). The output of these rules may be vetted against a database that stores people, places, and things that the content enrichment framework utilizes to create an abbreviation or other dictionary.

The semantic model may incorporate a governance model that provides core elements of governance that are defined as a part of this pattern and may include: (i) organization and roles and (ii) business-process steps. The governance model may form a matrix with business-process along the X-axis and organizations along the Y-axis. In each of the matrix “cells,” a customer onboarding business process responsibility assignment matrix (e.g., RACI) is allocated. Thus, any outlier behavior indicated will be in a cell, and escalation rules can be applied based on which of RACI governance roles (i.e., responsible (R), accountable (A), consulted (C), and informed (I)) is identified within the cell. TABLE 1 below is illustrative of a customer onboarding process:

TABLE 1

| | Defining | | Contractual | | | Organization |
|---|---|---|---|---|---|---|
| Customer | Relationship | Profiling | Documents | Approval | Activation | Escalation |
| Sales | R, A | C | C | I | A | Owner |
| | | | | | | Steward |
| Credit | C | R | R | R | I | Owner |
| | | | | | | Steward |
| Legal | C | R | A | R | I | Owner |
| | | | | | | Steward |
| Compliance | I | A | C | R, A | I | Owner |
| | | | | | | Steward |
| (Onboarding) | I | I | I | I | R | Owner |
| Operations | | | | | | Steward |
| Process | Owner | Owner | Owner | Owner | Owner | Owner |
| Escalation | Steward | Steward | Steward | Steward | Steward | Steward |

With regard to FIG. 1, an illustration of an illustrative regulated business environment 100 in which a business entity, such as a bank, operates under government regulations and performs customer onboarding reviews is shown. The regulated business environment 100 is shown to include a business entity 102, such as a Tier-1 bank, that is regulated by government regulators 104. As understood in the art, government regulators 104 define government regulations 106a under which industries operate. The government regulations 106a may be defined in a number of ways, including laws, rules, limits, or any other format used to specify duties, rights, constraints, limits, responsibilities, and so forth as defined by the government. As shown, the government regulations 106a may be distributed to or otherwise imposed on the business entity 102, which, of course, is forced to comply so as to avoid violations that often come with steep fines on violators. The government regulations 106a are generally published by the government regulators 104 on both paper and in an electronic format. Although not shown, it should be understood that industry leadership groups, such as standards organizations (e.g., International Organization for Standardization (ISO)), that are not governmental bodies may also define rules, parameters, or other criteria under which industry participants may choose to operate so as to be compliant with other industry leaders.

In addition to the business entity 102, the government regulations 106a may be utilized by a third-party service provider 108, such as a consulting firm (e.g., KPMG), that may specialize in interpreting the government regulations. As understood in the art, the interpretation of government regulations are performed by subject matter experts (SMEs). From the interpretation, the third-party service provider 108 may generate government regulations 106b that are in a different format, such as a computer-executable format, that can be used by the business entity 102 for ensuring that the government regulations 106b are being followed while conducting business (e.g., customer onboarding by a bank). It should be understood that the business entity 102 may alternatively perform the interpretation of the government regulations 106a. However, in most heavily regulated industries, significant reliance on third-party service providers who specialize in interpreting regulations and assist companies in complying with the government regulations 106a are utilized to reduce the risk of the business entity 102 violating the government regulations 106a.

In addition, the business entity 102 may provide the third-party service provider 108 with business rules 110a with which the business entity 102 follows, and the third-party service provider 108 may interpret and generate business rules 110b in a format that is in the same or similar format as that of the government regulations 106b. It should be understood that the business entity 102 may alternatively perform the interpretation of the business rules 110a. The business entity 102 may utilize a rationalized set of assertions 112 composed of the government regulations 106b and business rules 110b for customer onboarding or other business or government regulation compliance requirements.

More particularly, the business entity 102 may operate to service potential customers 114 by collecting organizational (e.g., articles of incorporation) and/or operational documents (e.g., trade settlement documents) 116 from a potential customer. Utilizing the rationalized set of assertions 112, or either of the government regulations 106b or business rules 110b, customer onboarding or compliance review may be performed in an semi-automated or automated manner. Business data may be automatically generated and/or collected from the documents 116, depending on the format of the documents 116, for use in applying the set of assertions 112, as further described hereinbelow. Resulting from applying the set of assertions 112 to the business data contained in the documents 116, an onboarding approval or rejection report 118 may be generated and communicated to the potential customer 114a. Alternatively, rather than sending a complete report, an abbreviated or summary report or notice may be generated and provided to the potential customer 114a.

With regard to FIG. 2, an illustration of an illustrative network environment 200 of the business entity that supports customer onboarding in the government regulated environment of FIG. 1 in accordance with the principles of the present invention is shown. The network environment 200 includes a business entity server 202 configured to apply assertions to business data of potential customers in performing customer onboarding compliance reviews. The business entity server 202 may be in communication with a government regulator server 204 that includes a data storage unit 205 configured to store a data repository. The storage unit 205 may be configured to store information of the government regulator, including government regulations. The business entity server 202 may communicate with the government regulator server 204 via a communications network 206. It should be understood that the server 204 and/or storage unit 205 may be managed by any other entity other than the government regulator or that the government regulators may be available from any other source and in any format.

The business entity server 202 may include a processing unit 208 formed of one or more computer processors that execute software 210. The software 210 may be configured to cause the processing unit 208 to perform a variety of functions, such as customer onboarding compliance functions, in accordance with the principles of the present invention. The processing unit 208 may be in communication with memory 212 operable to store data and software, input/output unit 214 configured to communicate data over the communications network 206 using any number of communications protocols, as understood in the art, and storage unit 216. The storage unit 216 may be configured to store data repositories 218a-218n (collectively 218). In one embodiment, the business entity server 202 may access government regulations 219, which may be stored in a variety of formats, including text, HTML, PDF, XML, of otherwise. Within the data repositories 218, rationalized assertions 220, which may include government regulation assertions 220a and/or business entity assertions 220b. As will be described further herein, the government regulation assertions 220a and business entity assertions 220b are in a computer-executable format that allows for the processing unit 208 to perform customer onboarding compliance functions, among others. The data repositories 218 may also be configured to store business compliance data 221, including audit records 221a, compliance reports 221n, and any other compliance results data.

In one embodiment, a third-party server 222 may be configured to perform the same or similar functions as the business entity server 202 to enable a business entity to outsource various compliance functions, such as customer onboarding, to the third-party, such as a consulting firm. The third-party server 222 may include a processing unit 224 composed of one or more computer processors configured to execute software 226. The processing unit 224 may be in communication with memory 228, input/output unit 230, and storage unit 232. The storage unit 232 may be configured to store one or more data repository 234a-234n (collectively 234). The data repositories may store government regulation assertions (not shown) in a computer-executable format, business entity assertions (not shown) in a computer-executable format, and/or any other data for use in conducting business compliance or any other functions.

As shown, computers 236a-236n (collectively 236) may be in communication with third-party server 222, and be used by subject matter experts 238a-238n (collectively 238). The subject matter experts 238 may analyze, interpret, and encode the government regulations 219 using an enriched vocabulary (not shown). The enriched vocabulary may be standardized or proprietary as developed by the third-party and be specific toward interpreting government regulations, such as those directed to customer onboarding. The enriched vocabulary may be used as part of creating a semantic web (SW) standard model, such as RDF or RDF triple. As shown, the subject matter experts 238 may create government regulation assertions 220a and business entity assertions 220b by parsing the government regulations and business rules or rules derived therefrom manually, semi-automatically, or automatically by the subject matter experts 238. The government regulation assertions 220a and business entity assertions 220b may be stored in the data repositories 234 for use by the third-party server (e.g., performing a compliance review) and/or communicating the government regulation assertions 220a and business entity assertions 220b to the business entity server 202 for storage in the data repository 218a. Of course, because every business entity has unique business rules, the business entity assertions 220b are specifically associated with the associated business entity.

As further shown in FIG. 2, potential customer computing devices 240a-240n (collectively 240) may be in communication with the business entity server 202. In this case, the potential customers are shown prior to being actual customers of the business entity and have to be processed through a customer onboarding compliance review process. Once the potential customer is approved to be a customer after passing the customer onboarding compliance review process, the computing devices are deemed customer computing devices. Each of the potential customer computing devices 240 have associated storage units 242a-242n (collectively 242) respectively inclusive of data repositories 244a-244n (collectively 244) and 246a-246n (collectively 246). The data repositories 244 and 246 may store corporate organization documents (e.g., management or governance documents, such as quarterly corporate filings and tax form filings) and operations documents (e.g., business transaction documents, such as stock trades or sales records).

In operation, the potential customer computing device 240a may communicate organization/operations documents (OODs) 248 to the business entity server 202 and/or third-party server 222 for processing thereat. It should be understood that the principles of the present invention may operate by the business entity imaging (e.g., scanning) paper documents as opposed to communicating them over the network 206. The business data contained in the documents 248 may be unstructured (e.g., text documents, reports, etc.), semi-structured (e.g., emails, websites, business forms), or structured (e.g., structured databases, XML feeds) and be inclusive of actual data and/or associated metadata. In the case of documents being unstructured, a conventional OCR process may be utilized to “read ” data, and tags may be applied to the data using a vocabulary defined by the business entity and/or third-party so that an automated compliance review process may thereafter be conducted. The rationalized assertions 220 may be applied to the business data of the documents 248 by the business entity server 202 and/or third-party server 222 for performing a customer onboarding compliance review, as further described herein. In response, an approval/denial report 250, which may be a full compliance report, summary report, or simply an approval or denial notice, may be communicated to the potential customer computing device 240a. It should also be understood that the business entity server 202 may send an outsource request (not shown) to the third-party server 222 to perform the customer onboarding compliance review and the approval/denial report 250 may be communicated to the business entity server 202 for storage and communication to the potential customer computing device 240a.

After a customer is onboarded, the principles of the present invention may provide for monitoring public documents of the customer so as to perform post-onboarding monitoring of the customer. In one embodiment, websites and publicly available databases 252a-252n, such as government websites (e.g., secretary of state offices), public reporting document websites (e.g., quarterly and annual report websites), news websites, and so forth may be monitored and documents associated with the customer may be collected to form new business data. The new business data from the documents may be collected and added to the previous business data. The assertions may be applied to the new business data being fed back, thereby ensuring that the customer continues to remain compliant with the customer onboarding compliance requirements along with any other compliance requirements of the business entity.

With regard to FIG. 3, an interaction diagram of an illustrative process 300 for a business entity to perform customer onboarding utilizing the principles of the present invention is shown. The process 300 is shown to include a number of components as part of the process, including computer(s)/subject matter expert(s) 238, server 222, government regulations server 204, business entity server 202, and potential customer computing device 240a. The process 300 may start at step 302, where government regulations may be communicated to the server 222 and computer(s)/subject matter expert(s) 236. The business entity server 202 may communicate business policies at step 304 to the server 222 and computer(s)/subject matter expert(s) 236/238. At step 306, the government regulations and business policies may be interpreted by the computer(s)/subject matter expert(s), and encoded assertions may be generated thereby at step 308. In addition, unique identifiers may be assigned to each of the encoded assertions. The unique identifiers may be numeric (e.g., generated in an ordered sequence or otherwise, alphanumeric (e.g., name of assertion), or otherwise (e.g., memory or database location identifier)). The unique identifiers may be used for managing the assertions and for use in generating an audit trail.

At step 310, a workflow for performing a customer onboarding process (or any other KYC regulated process, for example) may be established manually (e.g., by a subject matter expert), semi-automatically (e.g., heuristic guidance for a user to accept or modify), or automatically (e.g., heuristic guidance, using neural networks, etc.). Each step of the workflow may be assigned a unique identifier. At step 312, the encoded assertions may be assigned to or grouped into the steps of the workflow. The encoded assertions may be grouped in a logical manner to perform functions of the steps of the workflow and the unique identifiers of the encoded assertions may be associated with the step(s) with which each of the encoded assertions are assigned, as further described herein. Moreover, in assigning the grouped encoded assertions to the steps of the workflow, the unique identifiers of each of the encoded assertions may be assigned to each of the unique identifiers of the steps of the workflow. For example, if encoded assertions 1-10 exist and there are four steps A-D in the workflow, workflow step A may be assigned encoded assertions 1, 2, 3; workflow step B may be assigned encoded assertions 4, 5; workflow step C may be assigned encoded assertions 6, 7; and workflow step D may be assigned encoded assertions 8, 9, 10. The workflow steps are meant to perform certain workflow functions, so the encoded assertions assigned to each of the workflow steps are to be logically related to the workflow step into which it is applied. It should be understood that an encoded assertion may be grouped with multiple, different groups and assigned to more than one workflow step.

The grouped encoded assertions may be communicated to the server 222 at step 312. It should be understood that the computer(s) 236 being used by the subject matter expert(s) 238 may cause the operations of steps 306-312 to be performed directly by the server 222, thereby eliminating the need to communicate the workflow and encoded assertions to be communicated at step 314.

At step 316, the server 222 may communicate the workflow and grouped encoded assertions to the business entity server 202 for the workflow to be performed by the business entity server 202. The server 222, which may be that of a third-party, may additionally or alternatively execute the workflow process on business data that may be provided to the server 222 or accessed at the business entity server 202 or elsewhere. At step 318, the potential customer computing device 240a may communicate business documents of the customer to the business entity server 202. It should be understood that any technique and communications protocol may be utilized in communicating the business documents from the computing device 240a to the business entity server 202.

At step 320, business data from the business documents may be generated. In generating the business data, a variety of parsing techniques may be utilized depending on the format of the business documents. That is, the business documents may be non-structured, semi-structured, or structured, as previously described, and different parsing techniques, as understood in the art, may be utilized to generate business data based on those business documents.

At step 322, the grouped encoded assertions may be applied to the business data based on the workflow steps using an orchestration engine, where the orchestration engine causes the workflow to automatically step through the steps of the workflow and apply each of the assertions associated at each respective step. The application of the grouped encoded assertions may be automatic or semi-automatic (e.g., steps manually selected and applied and results of each step displayed for a user to monitor). At step 324, compliance of the government regulations and/or business policies may be determined. As each assertion applied to the business data produces a Boolean result, the determination of compliance may be a YES or a NO answer. Alternatively, the determination may be a percentage of YES and NO answers (e.g., 86% YES/NO). In one embodiment, the result of applying an assertion to the business data may also provide for an error code or reason for the compliance data not complying with the assertion. Such reasons may include “data not found,” “insufficient data,” “data does not match allowable parameters,” and several other possible reasons for non-compliance.

In addition to applying each of the assertions to the business data, an audit trail may be created by the business entity server 202 recording unique identifiers associated with each of the workflow steps along with unique identifiers of each of the assertions that are applied to the business data. The audit trail enables the business entity to instantly provide a record of actual government regulations that were applied to business data to business executives and/or government regulators. For example, using the previous example with four workflow steps, each of the assertions 1-10 that were applied to particular business data can be listed, time-stamped as of the date and time of execution, identification of employee initiated the workflow, resulting compliance report, users who accessed the compliance report, and so on. In addition, the unique identifiers of the steps of the workflow and assertions may be presented in an audit trail report or simply used to manage associations of data (e.g., assertions and workflow steps) for display in the audit trail report. By being able to being able to provide an exact audit trail of the compliance efforts performed for complying with business rules and/or government regulations, the business entity can avoid potentially huge fines that are routinely levied against companies by government regulators as a result of not being able to produce verifiable audit records of compliance activities.

At step 326, a compliance report may be generated. The compliance report may include a listing of results of each assertion applied to the business data, a summary of each of the workflow steps, an overall summary as to percentage of passes/fails of each assertion and/or each workflow step, or a simple pass/fail of the compliance test defined by the workflow. At step 328, an approval/denial report may be communicated from the business entity server 202 to the potential customer computing device 240a. Other forms of communicating the approval/denial report from the business entity to the potential customer may additionally or alternatively be provided. It should be understood that the ordering of the steps 302-328 are illustrative and that alternative ordering may be utilized in accordance with the principles of the present invention. Moreover, it should be understood that additional and/or alternative steps may be utilized in performing the customer onboarding or other compliance process.

With regard to FIG. 4, a block diagram of illustrative modules 400 that may be executed by a computing system for performing compliance of business data in accordance with the principles of the present invention is shown. The modules 400 may include a policy engine 402, execution engine 404, content enrichment engine 406, and orchestration engine 408, and each of these engines 402-408 may operate in conjunction with one another. However, although each of the modules 400 are shown as a set, it should be understood that the policy engine 402 may operate separate from the other engines as once the assertions are grouped into decision-tables for execution, the execution engine 404, content enrichment engine 406, and orchestration engine 408 may be operated independently. Thus, a third-party provider may generate the decision-tables for execution and a business entity may execute the decision-tables on business data of potential customers, for example, as previously described.

The policy engine 402 may use ontology modeling to encode business policies as assertions in a semantic web format or web-based ontology language (OWL), such as an RDF format, where the RDF format may be an RDF triple and modeled as subject-predicate-object. The assertions may be grouped into decision-tables for execution. Each decision table is a reusable block of assertions and usage may be orchestrated by a standard business process tool. The policy model 402, thus, define data requirements and assertions for use by the execution engine 404.

The execution engine 404 may be a stateless machine that understands the assertion groups in the decision-tables. Execution is designed to enact or apply the assertions (e.g., business policies, government regulations) on business data. The business data may be unstructured, semi-structured, and structured, as previously described. The business data may be “inverted indexed” to enable advanced search and query capabilities across structured, semi-structured, and unstructured data and associated dashboards.

The content enrichment engine 406 may provide a framework from which a designed outcome of modeling policies as assertions for the policy engine is a domain-rich vocabulary that represents business semantics and is represented as an ontology model. The semantic ontology model enhances a natural language interpreter that allows for understanding business documentation that is in unstructured or semi-structured form, thereby allowing the business data to be processed by a computer as opposed to being manually entered.

The orchestration engine 408 is used to create a model-driven business process or pattern. The orchestration engine 408 allows the orchestration of decision-tables to enact a business process. That is, the ontology-model in the policy engine 402 determines the sequence in which the decision-tables are to be executed and represents the model that drives the business process (i.e., a model-driven business process). The orchestration engine 408 is executed as a state machine.

In operation, every government regulation and business rule may be modeled into the policy engine 402 as assertions using a business requirements document (BRD), and create rules for automatically “reading” documents. In creating the policy rules, the regulations may be broken down to guidelines of which the business entity should follow along with business policies that are particular to the business entity and then combined to create a complete set of policy rules. Three steps may be used in a decision model, including (i) create a decision table (TABLE 2) based on Decision Model Notation (DMN), (ii) perform XML encoding (TABLE 3) of a decision table as an assertion (subject-predicate-object), and (iii) convert the XML encoded decision table into XMI, whereby the XMI output (TABLE 4) may be sent to feed the assertions to the execution engine in the web-based ontology language (e.g., RDF triple).

TABLE 2
Decision Model Notation: Decision Table
Decision Table Determine LegalNameLabel

| If | | If | | Then | |
|---|---|---|---|---|---|
| $document.documentType | | $document.nounPhrase | | $document.legalNameLabel | |
| Document Type | | Noun Phrase | | Legal Name Label | |
| Is | Articles of Incorporation | Is | “Name of Company” | Is | NameOfCompany |
| Is | Articles of Organization | Is | “Name of Organization” | Is | NameOfOrganization |
| Is | Tax Form W-9 | Is | “Name (as shown on | Is | businessName |
| | | | your income tax return) | | |

TABLE 3
Decision Model Notation: XML Encoding

<Decision name=“DetermineLegalNameLabel”>
<Decision_Rules>
<DecisionRule name=“Rule1”>
<Condition>
<Subject>
<DMN.InformationItem
xmi.idref=“DMN-InformationItem_$document.documentType”/>
</subject>
<operator>is</operator>
<operand>
<DMN.InformationItem xmi.idref = “DMN-InformationItem_Articles
Of Incorporation”/>

TABLE 4
Decision Model Notation: XMI Export (OWL)

<InformationItem
xmi.id=“DMN-InformationItem_$document.documentType”
Name=“$document.documentType”>
<Related_Element>
<OWLBase.OWLClass href=“OWLClass-Legal Document-Document
Type”/>
</Related_Element>
<Contains_Element/>
</InformationItem>

An example of a use case for KYC customer onboarding is provided below in TABLE 5. As shown, the use case defines a portion of a requirements document that can be used for defining a model for the policy engine 402.

TABLE 5
Decision Model Notation: XMI Export (OWL)

| | Client onboarding | |
|---|---|---|
| | ◯ | Regulation: US Patriot ACT/SECTION 326 |

| | |
|---|---|
| ▪ | KYC |

| | CIP | |
|---|---|---|
| ◯ | | Commercial Bank |

| | |
|---|---|
| ▪ | Address |
| ▪ | Legal Name |
| ▪ | Tax ID |

A report generator 410 may also be utilized to generate reports of policies being applied to business data in performing a compliance review. The report generator 410 may also be utilized to present listings of assertions, listings of workflow(s) and groupings of assertions at each step of the workflow(s), and so forth. As a result of utilizing assertion groups formatted in a computer-executed format, such as an RDF triple, for example, and using decision model notation for performing regulatory compliance operations, such as customer onboarding, as further provided in co-pending U.S. Patent Application having application Ser. No. ______ entitled “SYSTEM AND METHOD FOR CUSTOMER ONBOARDING”; the contents of which are hereby incorporate by reference in their entirety, optimal regulatory compliance reviews of business data may be performed.

Although using assertions to perform government regulatory compliance reviews of business data is an optimal solution, the principles of the present invention further provide for supporting less-optimal solutions of rules-based systems by publishing a rules-based version of the assertions. An assertions-to-rules translator 412 may be configured to convert the assertions in an RDF triple, or other semantic web model, to rules for use in a rules-based engine. The translator 412 may use conversion logic to convert the assertions from a subject-predicate-object format to an “IF condition THEN result” format. The rules stored in the rules-based engine may be applied to business data stored in a structured database, such as an SQL database.

In one embodiment, assertions can be translated into rules for use in a traditional rules-based engine using Extensible Stylesheet Language Transformations (XSLT). XSLT is a language for transforming XML documents into other XML formats, and may also provide support for emerging XML based industry standards, such as Production Rule Representation (PRR), which is a standard under development at the Object Management Group (OMG), and a related standard for Rule Interchange Format (RIF) is under development at W3C (World Wide Web Consortia). Alternative conversion protocols or techniques for converting assertions in an RDF triple format into assertions in a rules-based format may be utilized. Alternative computer-executable formats for the assertions and rule-based formats may be utilized in accordance with the principles of the present invention, as well.

A subscription module 414 may be configured to generate a user interface and collect and verify identification information from users who subscribe or license the rules converted from the assumptions by the translator 412. In collecting and verifying information from the users, the subscription module 414 may receive identification information from a user via a user interface who wants to download the rules, compare the identification information to existing subscriber information, and, in response to verifying that the user is a subscriber, enable the user/subscriber to download the rules. The identification information may include a subscriber identifier issued by a third-party provider of the rules. Other information, such as name, address, company name, license identifier, or otherwise may be used for verifying that the user is a valid subscriber.

Illustrative assertions is shown in a decision table in TABLE 6 below. TABLE 6 provides rules, sub-rules, documents and XML field names at which the data can be obtained to answer each of the respective assertions. The decision table provides for a group of assertions to perform a function, such as a step in a workflow. In interpreting the assertions to rules, the rules may be grouped or group identifier(s) may be associated with each assertion to further assist a subscriber for using the rules against business data. It should be understood that although the assertions may be meant for a particular purpose (e.g., customer onboarding), that a subscriber may utilize the rules with a rules-based engine for other purposes.

TABLE 6
Example Decision Table

| UC Step Assertion | Sub-Assertion | Document | XML Field Name |
|---|---|---|---|
| Step 1 Check if valid W-8 exists | a) Check if document is correct | W-8BEN-E | docType |
| | W-8 | | |
| Step 1 Check if valid W-8 exists | i. Is document a W-8BEN-E? | W-8BEN-E | docType |
| | AND | | |
| Step 1 Check if valid W-8 exists | ii. Is EIN provided by sales same | W-8BEN-E | EIN |
| | as “EIN” on document? OR | | |
| Step 1 Check if valid W-8 exists | iii. Is Legal Name/Address | W-8BEN-E | entityStreetAddress, |
| | provided by sales same as “Full | | entityCityAddress, |
| | Legal Name “/”Address of | | entityCountryAddress |
| | Principal Business” on | | |
| | document? | | |
| Step 1 Check if valid W-8 exists | b) Check if W-8BEN-E is valid | W-8BEN-E | docType |
| Step 1 Check if valid W-8 exists | i. Is “Legal Entity Status” | W-8BEN-E | entityStatus |
| | complete? AND | | |
| Step 1 Check if valid W-8 exists | ii. Is “Notional Principal | W-8BEN-E | notionalPrincipalContracts |
| | Contracts” complete? AND | | |
| Step 1 Check if valid W-8 exists | iii. Is “FATCA Status” | W-8BEN-E | fatcaStatus |
| | complete? AND | | |
| Step 1 Check if valid W-8 exists | 1. Is “FATCA Status” = | W-8BEN-E | fatcaStatus, |
| | “Participating FFI” AND | | FFIRDCFFIConfirmation, |
| | “FFI/RDCFFI Confirmation” | | fatcaID |
| | checked AND “FATCA ID” | | |
| | filled out? OR | | |

With regard to FIG. 5, a screenshot of an illustrative user interface 500 that enables a user to download rules for government regulations from a third-party is shown. The user interface 500 may include a subscriber information section 502 to enable a user to submit subscription information. The subscriber information section 502 may include a text entry field 504 that enables the user to enter a subscription identifier, text entry field 506 that enables the user to enter a date of subscription, and text entry field 508 that enables the user to enter his or her name. It should be understood that additional and/or alternative subscription information may be requested from the user. The user interface 500 may also include an interactive table 510 that enables the user to select one or more set of available regulation rules 512a-512n (collectively 512) that are currently available. The available regulatory rules 512 may be converted from computer-executable assumptions (e.g., in an RDF triple format) and configured using conventional rules for a rules-based engine to execute. Although not shown, the user interface 500 may also list selectable data model protocols along with selectable database protocols that the available rules 512 may support. Furthermore, because government regulations change on a regular basis, rules representative of and derived from previous versions of government rules may be available for the user to select and download. A “submit” soft-button 514 may be available for the user to submit a request for downloading the rules selected from the selectable table 510. It should be understood that the user interface 500 is illustrative, and that any alternative configuration that enables a user to select rules for downloading pursuant to a subscription agreement with a third-party, such as a business consulting firm that models government regulations or other distributor of rules derived from government regulations, may be utilized in accordance with the principles of the present invention.

With regard to FIG. 6, a flow diagram of an illustrative process for availing executable rules for performing a government regulation compliance review using a rules-based engine is shown. The process 600 may start at step 602, where assertions may be encoded into a computer-executable format. At step 604, the assertions may be converted into a rules-based format. The conversion may utilize a translator for translating assertions to rules (i.e., assertions in a rules-based format). At step 606, the assertions in the rule-based format may be availed for execution in a rules-based engine for applying the assertions to business data being stored in a structured database. That is, The rules-based engine may be utilized to operate in conjunction with a structured database, such as a SQL database.

In one environment, availing the assertions in the rules-based format may include storing the assertions in a data repository accessible via a communications network, such as the Internet. The encoded assertions may be in an RDF triple format. Encoding the assertions may include coding government regulations. Converting the assertions may include converting the assertions from an RDF triple format to the rules-based format. In one embodiment, the converting may be performed by using Extensible Stylesheet Language Transformation or other translation technique, as previously described herein. Additionally, a user interface may be generated and be accessible via a communications network for presenting at least one set of assertions in the rules-based format, and the user interface may further enable a subscriber to download the assertions in the rule-based format. A unique identifier may be assigned to each of the assertions, thereby enabling correspondence of an assertion in the computer-executable format with the corresponding assertion in the rules-based format. The encoded assertions may be stored in a NoSQL database, and the converted assertions may be stored in a SQL database.

With regard to FIG. 7, a flowchart of illustrative process for creating executable policy rules for a rules-based engine to execute is shown. The process 700 may start at step 702, where a set of policy interpretations to create a set of assertions may be modeled. The set of policy interpretations may be derived from policies by which an organization is to comply during business operations. For example, the policies may include government regulations. Alternatively, the policies may be business policies of the organization. At step 704, the set of assertions may be translated from a first ontology to be rules having a second ontology. The rules may have the second ontology being configured to be executable by a rule-based engine to apply the rules to business data stored in a structured database. The structured database may be a SQL database.

The first ontology of the assertions may cause the assertions to be in a computer-executable format. The process 700 may further be configured to assign a unique assertion identified to each respective assertion in the set of assertions, thereby enabling the rules corresponding to the set of assertions to be traceable. A set of policy interpretations may be modeled from a set of government regulations. The rules in the data repository may be published, thereby enabling a used to access the rules via a communications network. In response to receiving a request to access the rules via the communications network, an identifier associated with the user making the request may be recorded. The identifier may be a user identifier or a subscription identifier that enables the user to have access to the rules. A determination may be made as to whether the user has access to the rules based on the identifier. If the user has access to the rules, then the user may be granted access the rules in response to a determination being made that the user has access to the rules. Otherwise, the user may be prevented from accessing the rules in response to determining the user does not have a subscription to access the rules. In determining whether the user has access to the rules, a determination as to whether a subscription to access the rules exists for the user. The set of assertions may be stored in a non-structure database (e.g., NoSQL database). The translated set of assertions in the rules-based format may be applied to data stored in a structured database, such as a SQL database.

The previous description is of a preferred embodiment for implementing the invention, and the scope of the invention should not necessarily be limited by this description. The scope of the present invention is instead defined by the following claims.

What is claimed:

1. A method of availing executable rules for performing a government regulation compliance review using a rules-based engine, said method comprising:
encoding, by a processing unit, assertions into a computer-executable format;
converting, by the processing unit, the assertions from the computer-executable format to a conventional rules-based format; and
availing, by the processing unit, the assertions in the rules-based format for execution in a rules-based engine for applying the assertions to business data being stored in a structured database.

2. The method according to claim 1, wherein availing the assertions in the rules-based format includes storing, by the processing unit, the assertions in a data repository accessible via a communications network.

3. The method according to claim 1, wherein encoding includes encoding the assertions in an RDF triple format.

4. The method according to claim 3, wherein encoding assertions includes encoding government regulations.

5. The method according to claim 1, further comprising:
generating a user interface accessible via a communications network, the user interface presenting at least one set of assertions in the rules-based format; and
enabling a subscriber to download the assertions in the rules-based format.

6. The method according to claim 5, wherein generating a user interface may include causing the at least one set of assertions in the rules-based format for selection by a user from among multiple sets of assertions in the rules-based format.

7. The method according to claim 1, further comprising assigning a unique identifier to each of the assertions, thereby enabling correspondence of an assertion in the computer-executable format with a corresponding assertion in the rules-based format.

8. The method according to claim 1, further comprising:
storing the encoded assertions in a NoSQL database; and
storing the converted assertions in a SQL database.

9. A method for creating executable policy rules for a rules-based engine to execute, said method comprising:
modeling, using a processing unit, a set of policy interpretations derived from policies by which an organization is to comply during business operations to create a set of assertions; and
translating, by the processing unit, the set of assertions from a first ontology to be rules having a second ontology, the rules having the second ontology being configured to be executable by a rules-based engine to apply the rules to business data stored in a structured database.

10. The method according to claim 9, further comprising assigning, by the processing unit, a unique assertion identifier to each assertion in the set of assertions.

11. The method according to claim 9, wherein modeling a set of policy interpretations includes modeling a set of government regulations.

12. The method according to claim 9, further comprising publishing the rules in a data repository available to be accessed via a communications network.

13. The method according to claim 12, further comprising:
in response to receiving a request to access the rules via the communications network, recording an identifier associated with a user making the request;
determining whether the user has access to the rules; and
enabling the user to access the rules via the communications network in response to determining that the user has access to the rules,
otherwise, preventing the user to access the rules the of the communications network in response to determining that the user does not have access to the rules.

14. The method according to claim 13, wherein determining whether the user has access to the rules includes determining whether the user has a subscription to access the rules.

15. The method according to claim 9, further comprising:
storing the set of assertions in a non-structured database; and
storing the translated set of assertions in a structured database.
